(19) United States
(12) Patent Application Publication
(10) Pub. No.: US 2025/0192225 A1
(43) Pub. Date: Jun. 12, 2025

(54) SOLID ELECTROLYTE MATERIALS AND METHODS FOR MAKING THE SAME

(71) Applicant: Solid Power Operating, Inc., Louisville, CO (US)

(72) Inventors: Sean P. CULVER, Broomfield, CO (US); Bradley J. ROSS, Norman, OK (US); Victoria R. BACHTELL, Broomfield, CO (US); Michael C. MCNALLY, Boulder, CO (US)

(21) Appl. No.: 18/972,702

(22) Filed: Dec. 6, 2024

Related U.S. Application Data
(60) Provisional application No. 63/608,093, filed on Dec. 8, 2023.

(51) Int. Cl. H01M 10/0562

(52) U.S. Cl. CPC H01M 10/0562; H01M 2300/008

(57) ABSTRACT

A sulfide-based solid electrolyte composition contains lithium, sulfur, and phosphorus, and is partially coated with an amorphous layer that includes an alkali metal halide. Alternatively, the sulfide-based solid electrolyte composition is dispersed in a matrix of an alkali metal halide. The sulfide-based solid electrolyte composition is suitable for use in solid-state batteries.

### CROSS-REFERENCE TO RELATED APPLICATION

This application is related to and claims priority under 35 U.S.C. § 119 (e) from U.S. patent application No. 63/608,093, filed Dec. 8, 2023, titled “Techniques for Coating Solid Electrolyte Materials,” the entire contents of which is incorporated herein by reference for all purposes.

### TECHNICAL FIELD

The present disclosure is directed to sulfide-based solid electrolytes for use in solid-state electrochemical battery cells.

### BACKGROUND

With traditional lithium-ion batteries that contain liquid electrolytes, ensuring optimal contact between the electrolytes and the active materials has been relatively easy to accomplish. However, with the advent of solid-state batteries, which use a solid electrolyte material in place of liquid electrolyte, ensuring this optimal contact between the electrolytes and the active materials is more challenging. One of the tactics used to create optimal contact between the solid electrolyte and the active material is to use a solid electrolyte with an average particle size smaller than the average particle size of the active materials being used. Fortunately, when the solid electrolyte material is synthesized through traditional ball milling techniques, the average particle size of the resulting solid electrolyte is often much larger than that of the active materials.

However, when the synthesized electrolyte is further milled or ground to reduce the average particle size to a desired amount, a large amount of fine particles, which may be ten to one hundred times smaller than the desired particle size, are created. These fine particles increase the viscosity of a slurry used to create the layers of a solid-state electrochemical cell, which makes later processing difficult.

There has been little work on the growth of solid electrolyte particles, especially those of sulfide based solid electrolyte materials. Growing the particle size of sulfide-based solid electrolyte materials becomes increasingly important when the synthesis techniques used to generate the material produces solid electrolyte particles that are too small.

It is with these observations in mind, among others, that aspects of the present disclosure were conceived.

### SUMMARY

Provided herein are solid electrolytes that include lithium, sulfur, and phosphorus. At least a portion of the solid electrolyte is coated by an amorphous layer that includes an alkali metal halide. In some embodiments, the alkali metal halide includes lithium iodide (LiI). In some embodiments, at least 5% of the surface of the solid electrolyte is coated by the amorphous layer.

Further provided herein are solid electrolyte compositions that include a plurality of solid electrolyte particles and an alkali metal halide, wherein the plurality of solid electrolyte particles are dispersed in a matrix of the alkali metal halide.

Further provided herein are solid-state batteries that include an alkali metal halide and a plurality of solid electrolyte particles comprising lithium, sulfur, and phosphorus, and wherein the plurality of solid electrolyte particles are dispersed in a matrix of the alkali metal halide. In some embodiments, the solid-state battery includes an anode layer, a cathode layer, and a separator layer, and one or more of the anode layer, the cathode layer, and the separator layer includes the solid electrolyte.

Further provided herein are solid-state batteries that include a solid electrolyte comprising lithium, sulfur, and phosphorus, wherein at least a portion of a surface of the solid electrolyte material is covered by an amorphous layer comprising an alkali metal halide. In some embodiments, the solid-state battery includes an anode layer, a cathode layer, and a separator layer, and one or more of the anode layer, the cathode layer, and the separator layer includes the solid electrolyte.

Further provided herein is a method for making a solid electrolyte composition. The method includes combining a solid electrolyte with an alkali metal halide; heating the combined solid electrolyte with an alkali metal halide to melt the alkali metal halide; and cooling the combined solid electrolyte and alkali metal halide.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1A shows a sulfide-based solid electrolyte particle fully coated by an amorphous layer of an alkali metal halide.

FIG. 1B shows a sulfide-based solid electrolyte particle partially coated by an amorphous layer of an alkali metal halide.

FIG. 1C shows a plurality of sulfide-based solid electrolyte particles dispersed in an amorphous matrix.

FIG. 2 shows the particle size distribution of the electrolyte material produced in Example 2 (0 wt % lithium iodide (LiI), Δ), Example 3 (1 wt % LiI, ∘), Example 5 (3 wt % LiI, ♦), and Example 7 (5 wt % LiI, +).

FIG. 3 shows the particle size distribution of the electrolyte material produced in Example 1 (0 wt %, □), Example 5 (3 wt %, ♦), and Example 8 (3 wt % LiI, Δ).

### DETAILED DESCRIPTION

The inventors have developed a process for growing sulfide-based solid electrolyte particles wherein a sulfide-based solid electrolyte material in a crystalline form is mixed and heated with an alkali metal halide. The alkali metal halide melts and forms a flux fusing the primary particles of the sulfide-based solid electrolyte together. Importantly, the alkali metal halide is not incorporated into the crystal structure of the sulfide electrolyte material as a result of this process. Rather, the alkali metal halide forms essentially a coating around the sulfide-based solid electrolyte primary particles, and/or forms a matrix surrounding the sulfide-based solid electrolyte particles.

Without wishing to be bound by theory, the data suggests that the alkali metal halide is not incorporated into the crystal structure of the electrolyte material and only remained on the surface of the primary particles. When new elements are introduced into the electrolyte's crystal structure, properties such as ionic conductivity may be lowered. Growing particles without incorporating other elements as described herein prevents the lowering of the ionic conductivity and allows for production of a sulfide electrolyte material with a desirable particle size.

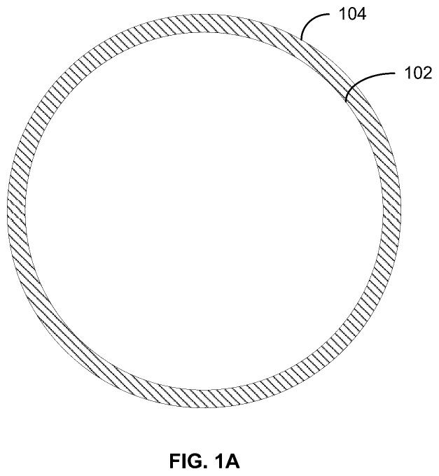

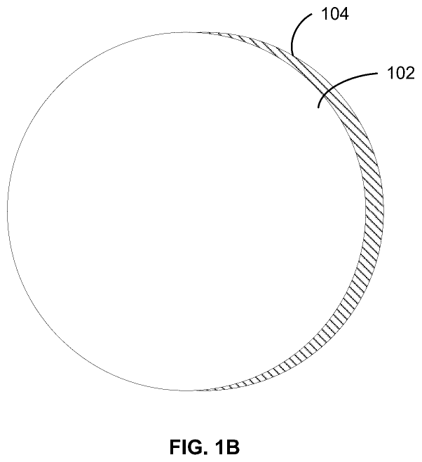

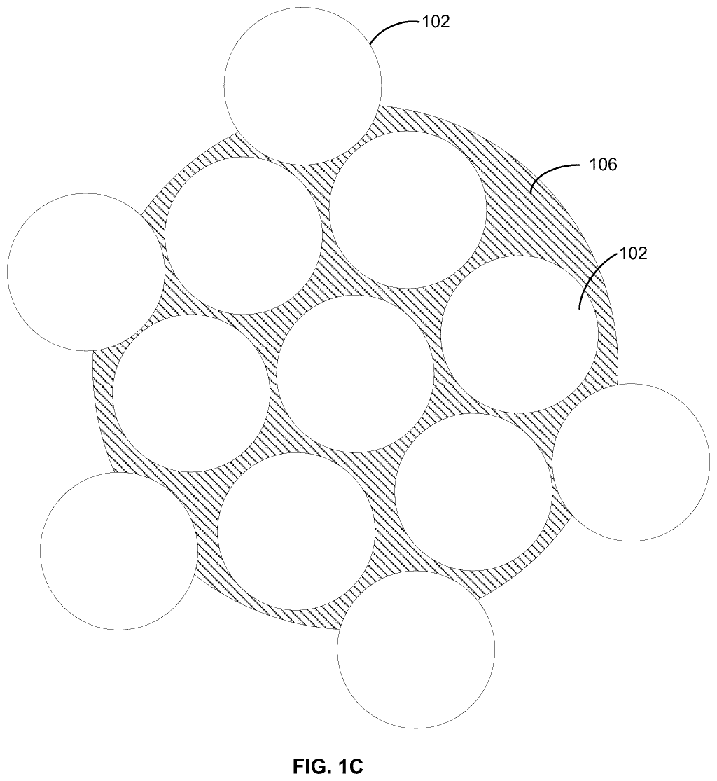

The sulfide-based solid electrolyte material resulting from the process described herein may therefore be at least partially covered by an amorphous layer of the alkali metal halide, as shown in FIGS. 1A-1B. FIG. 1A shows a sulfide-based solid electrolyte particle 102 fully coated by an amorphous layer of an alkali metal halide 104 and FIG. 1B shows a sulfide-based solid electrolyte particle 102 partially-coated by an amorphous layer of an alkali metal halide 104.

The amorphous layer may cover at least 5% of the surface of the solid electrolyte particles, such as at least 10%, at least 25%, at least 50%, at least 75%, or at least 90% of the surface of the solid electrolyte particles. In some embodiments, the amorphous layer covers 100% of the surface of the solid electrolyte particles.

The amorphous layer of the alkali metal halide may have a thickness of less than 100 nm. For example, the amorphous layer of the alkali metal halide may have a thickness of less than 100 nm, less than 75 nm, less than 50 nm, less than 25 nm, less than 10 nm, less than 5 nm, or less than 1 nm. The amorphous layer of the alkali metal halide may have a thickness of from about 1 nm to about 100 nm, such as from about 1 nm to about 10 nm, about 1 nm to about 25 nm, about 1 nm to about 50 nm, about 1 nm to about 75 nm, about 1 nm to about 100 nm, about 10 nm to about 100 nm, about 25 nm to about 100 nm, about 50 nm to about 100 nm, about 75 nm to about 100 nm, or about 10 nm to about 50 nm. As another example, the amorphous layer of the alkali metal halide may have a thickness of about 1 nm, about 5 nm, about 10 nm, about 20 nm, about 30 nm, about 40 nm, about 50 nm, about 60 nm, about 70 nm, about 80 nm, about 90 nm, or about 100 nm.

The coated sulfide-based solid electrolyte particles may be agglomerated by milling the sulfide-based solid electrolyte particles. The agglomeration may result in the coating layers of the alkali metal halide to form an amorphous matrix 106 as shown in FIG. 1C. In this embodiment, the amorphous matrix may have a thickness of less than 100 nm as described above relative to each individual sulfide-based solid electrolyte particle 102; in other words, there may be an amorphous layer between two sulfide-based solid electrolyte particles up to about 200 nm thick. The matrix may include void spaces between the sulfide-based solid electrolyte particles and the matrix surrounding the sulfide-based solid electrolyte particles, where no sulfide-based solid electrolyte or matrix is present. As shown in FIG. 1C, the amorphous matrix 106 may fully encapsulate the sulfide-based solid electrolyte particles 102, or the amorphous matrix may only partially encapsulate the sulfide-based solid electrolyte particles 102.

It should be apparent to those having ordinary skill in the art that although the sulfide-based solid electrolyte particles, the amorphous layer, and the amorphous matrix in FIGS. 1A-1C are depicted as spheres, this is done for the sake of simplicity in describing the invention and the compositions described herein are not limited to these depictions.

The alkali metal halide may include lithium iodide (LiI), lithium chloride (LiCl), lithium bromide (LiBr), lithium fluoride (LiF), sodium iodide (NaI), sodium chloride (NaCl), sodium bromide (NaBr), sodium fluoride (NaF), potassium iodide (KI), potassium chloride (KCl), potassium bromide (KBr), potassium fluoride (KF), or any combination thereof. Preferably, the alkali metal halide includes LiI.

In some embodiments, the alkali metal halide may include at least 90 wt % LiI and one or more additional alkali metal halides. For example, the alkali metal halide may include 90 wt % LiI or more, 91 wt % LiI or more, 92 wt % LiI or more, 93 wt % LiI or more, 94 wt % LiI or more, 95 wt % LiI or more, 96 wt % LiI or more, 97 wt % LiI or more, 98 wt % LiI or more, 99 wt % LiI or more, or 99.5 wt % LiI or more. Additionally, the alkali metal halide may include 10 wt % or less of one or more alkali metal halides, such as 10 wt % or less, 9 wt % or less, 8 wt % or less, 7 wt % or less, 6 wt % or less, 5 wt % or less, 4 wt % or less, 3 wt % or less, 2 wt % or less, 1 wt % or less, or 0.5 wt % or less. In some examples, the alkali metal halide includes 90 wt % LiI and 10 wt % LiBr, or 95 wt % LiI and 5 wt % LiBr, or 90 wt % LiI and 10 wt % LiCl, or 95 wt % LiI and 5 wt % Cl.

The sulfide-based solid electrolyte may be an electrolyte material that includes lithium, sulfur, and phosphorus, and optionally one or more halogens. In some embodiments, the sulfide-based solid electrolyte may be a material belonging to the Argyrodite family, which can be represented by the following formula:

Li_{(7-A-B)}PS_{(6-A-B)}X_{A}Y_{B}
where X and Y may each be independently selected from fluorine (F), chlorine (Cl), bromine (Br), and iodine (I),

$$0 \leq A \leq 2 , \\ 0 \leq B \leq 2 ,$$

and
wherein A+B≤2.

In certain embodiments, X is CI and Y is Br.

In certain embodiments, 0.5≤A≤2, 1≤A≤2, 1.5≤A≤2, 0≤A≤1.5, 0≤A≤1, 0≤A≤0.5, or 0.5≤A≤1.5. For example, A may be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.

In certain embodiments, 0.5≤B≤2, 1≤B≤2, 1.5≤B≤2, 0≤B≤1.5, 0≤B≤1, 0≤B≤0.5, or 0.5≤B≤1.5. For example, B may be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2. In some examples, B is 0.

Examples of sulfide-based solid electrolytes of the present disclosure include. Li₆PS₅Cl, Li₆PS₅Br, Li₆PS₅I, Li_{5.5}PS_{4.5}Cl_{1.5}, or Li_{5.5}PS_{4.5}BrCl_{0.5}.

In some embodiments, the sulfide-based solid electrolyte may include Li₂S—P₂S₅, Li₂S—P₂S₅—LiI, Li₂S—P₂S₅—GeS₂, Li2ₛ—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, Li₂S—S—SiS₂-LiₓMO_{y} (where x and y are positive numbers, and M is P, Si, Ge, B, Al, Ga or In), or any combination thereof. Halide solid electrolytes may have the structure Li-M-X, M is a metal element, and X is a halogen. These can be expressed by the generic formula Li_{α}M⁴⁺_{β}N³⁺_{(1-β)} X_{Ω}Y_{(6-Ω)}, where: 0≤β≤1; 0≤Ω≤6; α=6−[(β*4)+(1−β)*3]; X and Y are each independently a halogen selected from the group consisting of F, Cl, Br, and I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In yet another embodiment, the sulfide-based solid electrolyte may include Li₃PS₄, Li₄P₂S₆, Li₂P₃S₁₁, Li₁₀GeP₂S₁₂, Li₁₀SnP₂S₁₂, or any combination thereof. In a further embodiment, the solid electrolyte material may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The process for making the sulfide-based solid electrolyte compositions described herein includes combining the sulfide-based solid electrolyte with the alkali metal halide, and then heating the composition to generate a flux. Combining the sulfide-based solid electrolyte with the alkali metal halide may include mixing (including dry mixing and wet mixing), grinding, stirring, sheering, or tumbling the sulfide-based solid electrolyte and the alkali metal halide. The time of mixing, grinding, stirring, sheering, or tumbling is not particularly limited so long as the desired distribution of the alkali metal halide is achieved. The time of mixing, grinding, stirring, tumbling, or sheering may take place for a period of from 1 minute to 24 hours. The temperature of the mixing, grinding, stirring, sheering, or tumbling may be from about −20° C. to about 200° C. The mixing, grinding, stirring, sheering, or tumbling may be conducted in an inert atmosphere, such as nitrogen, argon, or hydrogen. Alternatively, the mixing, grinding, stirring, sheering, or tumbling may be conducted under vacuum. During this step, the primary particles of the solid-electrolyte material agglomerate in the flux to form larger agglomerated particles.

The alkali metal halide may be present during the combining step in an amount from greater than 0 wt % to about 10 wt % of the combined weight of the alkali metal halide and the sulfide-based solid electrolyte. For example, the alkali metal halide may be present in an amount from greater than 0 wt % to about 1 wt %, greater than 0 wt % to about 2.5 wt %, greater than 0 wt % to about 5 wt %, greater than 0 wt % to about 7.5 wt %, greater than 0 wt % to about 10 wt %, about 0.1 wt % to about 10 wt %, about 1 wt % to about 10 wt %, about 2.5 wt % to about 10 wt %, about 5 wt % to about 10 wt %, about 7.5 wt % to about 10 wt %, or about 0.1 wt % to about 5 wt % of the combined weight of the alkali metal halide and the sulfide-based solid electrolyte. As another example, the alkali metal halide may be present in an amount of about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, or about 10 wt %.

A solvent may also be combined with the sulfide-based solid electrolyte with the alkali metal halide. The solvent may include a hydrocarbon solvent, an ester solvent, an ether solvent, a nitrile solvent, or any combination thereof. Once the combining step is complete, the solvent is removed from the sulfide-based solid electrolyte and alkali metal halide mixture. Removing the solvent may be accomplished by evaporation or filtration.

After the combining step, the combined sulfide-based solid electrolyte and the alkali metal halide are heat treated to a temperature of 250° C. or greater, such as 300° C. or greater, 350° C. or greater, 400° C. or greater, 450° C. or greater, or 500° C. or greater. This temperature increase causes the alkali metal halide to melt and to act similarly to a flux. Additional mixing, grinding, stirring, sheering, or tumbling may be performed during the heating step. Methods and apparatuses for heating solid electrolyte materials are generally known in the art, such as a furnace, a rotary kiln, or fluidized bed heating. The heating step may be conducted for a period of 1 minute up to 24 hours. After heating, and once the temperature is reduced, the resultant sulfide-based solid electrolyte particles are at least partially coated by the alkali metal halide. During this step, the agglomerated particles may be broken up, which may contribute to fusing of primary particles and ultimately a primary particle with a larger particle size.

The sulfide-based solid electrolyte prepared as described herein may be incorporated into a separator layer, a cathode layer, an anode layer, or any combination thereof used in a solid-state electrochemical cell. The separator layer is disposed between the cathode layer and the anode layer. In some possible battery structures, the sulfide-based solid electrolyte is integrated in the cathode and/or anode layers.

The separator layer may include a binder and a sulfide-based solid electrolyte. In some embodiments, the sulfide-based solid electrolyte may be a sulfide-based solid electrolyte of the present disclosure. Alternatively or additionally, the sulfide-based solid electrolyte may include Li₂S—P₂S₅, Li₂S—P₂S₅—LiI, Li₂S—P₂S₅—GeS₂, Li₂S-P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, Li₂S—S—SiS₂-LiₓMO_{y} (where x and y are positive numbers, and M is P, Si, Ge, B, Al, Ga or In), or any combination thereof. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are each independently a halogen selected from the group consisting of F, Cl, Br, and I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂. Alternatively or additionally, the sulfide-based solid electrolyte may include Li₃PS₄, Li₄P₂S₆, Li₂P₃S₁₁, Li₁₀GeP₂S₁₂, Li₁₀SnP₂S₁₂, or any combination thereof. In a further embodiment, the sulfide-based solid electrolyte may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the sulfide-based solid electrolyte be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The separator layer may further include a binder. The binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly(vinylene difluoride-hexafluoropropylene) copolymer (PVdF-HFP), and the like. In another example, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly(methacrylate)nitrile-butadiene rubber (PMMA-NBR) and the like. Another approach would be to have the binder be one or more of an acrylic resin such as but not limited to polymethyl(meth)acrylate, polyethyl(meth)acrylate, polyisopropyl(meth)acrylate polyisobutyl (meth)acrylate, polybutyl(meth)acrylate, and the like.

The anode layer may include an anode active material, a sulfide-based solid electrolyte of the present disclosure, a binder, and a conductive additive. The sulfide-based solid electrolyte may be any sulfide-based solid electrolyte discussed herein. The binder may be any binder discussed herein.

The anode active material may include as Silicon (Si); a silicon alloy, Tin (Sn); Germanium (Ge); Carbon in the form of Graphite, Graphene, or Hard Carbon or similar; Lithium (Li); lithium alloy, Li₄Ti₅O₁₂ (LTO); or other known anode active materials or combinations thereof.

The conductive additive may include one or more conductive carbon materials such as carbon fiber, graphite, graphene, carbon black, conductive carbon, amorphous carbon, vapor grown carbon fiber (VGCF), activated carbon, and carbon nanotubes.

The cathode layer may include a cathode active material, a sulfide-based solid electrolyte of the present disclosure, a binder, and a conductive additive. The sulfide-based solid electrolyte may be any sulfide-based solid electrolyte discussed herein. The binder may be any binder discussed herein. The conductive additive may be any conductive additive discussed herein.

The cathode active material may include a Nickel-Manganese-Cobalt (NMC) material and may be represented by the formula LiNiₐMn_{b}Co_{c}O₂, wherein 0<a<1, 0<b<1, 0<c<1 and a+b+c=1. In some cases, the cathode active material may include NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or any combination thereof.

In another embodiment, the cathode active material may include a metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCo_{1-Y}Mn_{Y}O₂, LiNi_{1-Y}Mn_{Y}O₂ (0≤Y<1), Li(NiₐCO_{b}Mn_{c})O₄ (0<a<2, 0<b>2, 0<c<2, a+b+c=2), LiMn_{2-Z}Ni_{Z}O₂, LiMn_{2-Z}CO_{Z}O₄ (0<Z<2), LiCoPO₄, LiFePO₄, CuO, Li(NiₐCo_{b}Al_{c})O₂ (0<a<1, 0<b<1, 0<c<1, a+b+c=1), or any combination thereof. In yet another embodiment, the cathode active material may include a metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or any combination thereof. In still further embodiments, the cathode active material may include elemental sulfur(S). In additional embodiments, the cathode active material may includes a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or any combination thereof.

### ENUMERATED EMBODIMENTS

Embodiment 1: A solid electrolyte comprising lithium, sulfur, and phosphorus where at least a portion of a surface of the solid electrolyte is at least partially coated by an amorphous layer comprising an alkali metal halide.

Embodiment 2: The solid electrolyte of claim 1, wherein the alkali metal halide includes lithium iodide (LiI).

Embodiment 3: The solid electrolyte of claim 1, where the solid electrolyte is an Argyrodite material.

Embodiment 4: The solid electrolyte of claim 1, wherein the solid electrolyte has a molecular formula of:

Li_{(7-A-B)}PS_{(6-A-B)}X_{A}Y_{B},
wherein:
   X and Y are each independently selected from the group consisting of fluorine, chlorine, bromine, and iodine;

$$0 \leq A \leq 2 ; \\ 0 \leq B \leq 2 ; and \\ 0 \leq A + B \leq 2.$$

Embodiment 5: The solid electrolyte of claim 4, wherein X is CI and B is 0.

Embodiment 6: The solid electrolyte of claim 4, wherein X is CI, B is 0, and 1≤A≤2.

Embodiment 7: The solid electrolyte of claim 4, wherein X is CI, B is 0, and 1.25≤A≤2.

Embodiment 8: The solid electrolyte of claim 4, wherein X is CI, B is 0, and 1.5≤A≤2.

Embodiment 9: The solid electrolyte of claim 4, wherein X is CI and Y is Br.

Embodiment 10: The solid electrolyte of claim 4, wherein X is CI, Y is Br, and 1≤A+B≤2.

Embodiment 11: The solid electrolyte of claim 4, wherein X is CI, Y is Br, and 1.25≤A+B≤2.

Embodiment 12: The solid electrolyte of claim 4, wherein X is CI, Y is Br, and 1.5≤A+B≤2.

Embodiment 13: The solid electrolyte of claim 1, wherein the amorphous layer coats at least 5% of a surface of the solid electrolyte.

Embodiment 14: The solid electrolyte of claim 1, wherein the amorphous layer has a thickness of less than 100 nm.

Embodiment 15: A solid electrolyte composition comprising a plurality of solid electrolyte particles and an alkali metal halide, wherein the plurality of solid electrolyte particles are dispersed in a matrix of the alkali metal halide.

Embodiment 16: A solid-state battery comprising a solid electrolyte comprising lithium, sulfur, and phosphorus, wherein at least a portion of a surface of the solid electrolyte material is covered by an amorphous layer comprising an alkali metal halide.

Embodiment 17: The solid-state battery of claim 16, wherein the amorphous layer at least 5% of the surface.

Embodiment 18: The solid-state battery of claim 16, wherein the amorphous layer has a thickness of less than 100 nm.

Embodiment 19: A solid-state battery including an anode layer, a cathode layer, and a separator layer, wherein one or more of the anode layer, the cathode layer, and the separator layer includes a solid electrolyte comprising lithium, sulfur, and phosphorus, wherein at least a portion of the solid electrolyte material is covered by an amorphous layer of an alkali metal halide, and the alkali metal halide is LiI.

Embodiment 20: A method for making a solid electrolyte composition comprising:
combining a solid electrolyte with an alkali metal halide;
heating the combined solid electrolyte with an alkali metal halide to melt the alkali metal halide; and
cooling the combined solid electrolyte and alkali metal halide.

Embodiment 21: The method of claim 20, wherein the alkali metal halide includes lithium iodide (LiI).

Embodiment 22: The method of claim 20, wherein the combining includes grinding, stirring, sheering, or tumbling.

Embodiment 23: The method of claim 20, wherein the heating is conducted at a temperature of about 250° C. or greater.

Embodiment 24: The method of claim 20, wherein the solid electrolyte has a molecular formula of:

Li_{(7-A-B)}PS_{(6-A-B)}X_{A}Y_{B},
wherein:
   X and Y are each independently selected from the group consisting of fluorine, chlorine, bromine, and iodine;

$$0 \leq A \leq 2 ; \\ 0 \leq B \leq 2 ;$$

and
wherein 0≤A+B≤2.

### EXAMPLES

### Example 1

Li₂S, P₂S₄, and LiCl where mixed in a molar ratio to produce an electrolyte material having the formula Li_{(7-A)}PS_{(6-A)}Cl_{A}, wherein 1≤A≤1.5. The materials were ball milled and heated to the point of crystallization, about 450° C. The produced sulfide-based solid electrolyte was then milled to reduce the average particle size, thereby creating the material of Example 1, wherein the average particle size was characterized by a D₅₀ of about 1.39 μm. The average particle size was measured using a Mastersizer 3000.

### Example 2 (Comparative Example)

The material produced in Example 1 was heated to 500° C. for 1 hour to create the material of Example 2. The average particle size of the material of Example 2 was characterized by a D₁₀ of about 1.03 μm, a D₅₀ of about 3.74 μm, and a D₉₀ of about 30.1 μm. The surface area of the material produced in Example 2 was about 4.908 m²/g, and the ionic conductivity was about 3.65 mS/cm.

### Example 3

The material produced in Example 1 was mixed with 1 wt % LiI and heated to 500° C. for 1 hour to create the material of Example 3. The average particle size of the material of Example 3 was characterized by a D₁₀ of about 0.918 μm, a D₅₀ of about 3.87 μm, and a D₉₀ of about 34.4 μm. The surface area of the material of Example 3 was about 4.596 m²/g, and the ionic conductivity was about 3.67 mS/cm.

### Example 4

The material produced in Example 1 was mixed with 2 wt % LiI and heated to 500° C. for 1 hour to create the material of Example 4. The average particle size of the material of Example 4 was characterized by a D₁₀ of about 1.17 μm, a D₅₀ of about 11.4 μm, and a D₉₀ of about 50.8 μm. The ionic conductivity of the material of Example 4 was about 3.16 mS/cm.

### Example 5

The material of Example 1 was mixed with 3 wt % LiI and heated to 500° C. for 1 hour to create the material of Example 5. The average particle size of the material of Example 5 was characterized by a D₁₀ of about 1.26 μm, a D₅₀ of about 11.0 μm, and a D₉₀ of about 48.9 μm. The surface area of the material of Example 5 was about 2.943 m²/g, and the ionic conductivity was about 3.67 mS/cm.

### Example 6

The material of Example 1 was mixed with 4 wt % LiI and heated to 500° C. for 1 hour to create the material of Example 6. The particle size of the material of Example 6 was characterized by a D₁₀ of about 1.86 μm, a D₅₀ of about 41.2 μm, and a D₉₀ of about 104 μm. The ionic conductivity of the material of Example 6 was about 3.58 mS/cm.

### Example 7

The material of Example 1 was mixed with 5 wt % LiI and heated to 500° C. for 1 hour to create the material of Example 7. The average particle size of the material of Example 7 was characterized by a D₁₀ of about 3.15 μm, a D₅₀ of about 52.3 μm, and a D₉₀ of about 123 μm. The surface area of the material of Example 7 was about 2.304 m²/g, and the ionic conductivity was about 3.19 mS/cm.

### Example 8

The material of Example 5 was milled to reduce the average particle size, thereby creating the material of Example 8. The material of Example 8 was characterized by an average particle size with a D₅₀ of about 2.35 μm.

A summary of the data collected in each of Examples 1-7 is shown in Table 1.

TABLE 1

| | | | | | BET | IC |
|---|---|---|---|---|---|---|
| | wt % Li | D10 (μm) | D50 (μm) | D90 (μm) | (m²/g) | (mS/cm) |
| Example 1 | 0 | 0.478 | 1.39 | 8.18 | No Data | 3.39 |
| Example 2 | 0 | 1.03 | 3.74 | 30.1 | 4.908 | 3.65 |
| Example 3 | 1 | 0.918 | 3.87 | 34.4 | 4.596 | 3.67 |
| Example 4 | 2 | 1.17 | 11.4 | 50.8 | No Data | 3.16 |
| Example 5 | 3 | 1.26 | 11.0 | 48.9 | 2.943 | 3.67 |
| Example 6 | 4 | 1.86 | 41.2 | 104 | No Data | 3.58 |
| Example 7 | 5 | 3.15 | 52.3 | 123 | 2.304 | 3.19 |
| Example 8 | 3 | No data | 2.35 | No Data | No Data | No Data |

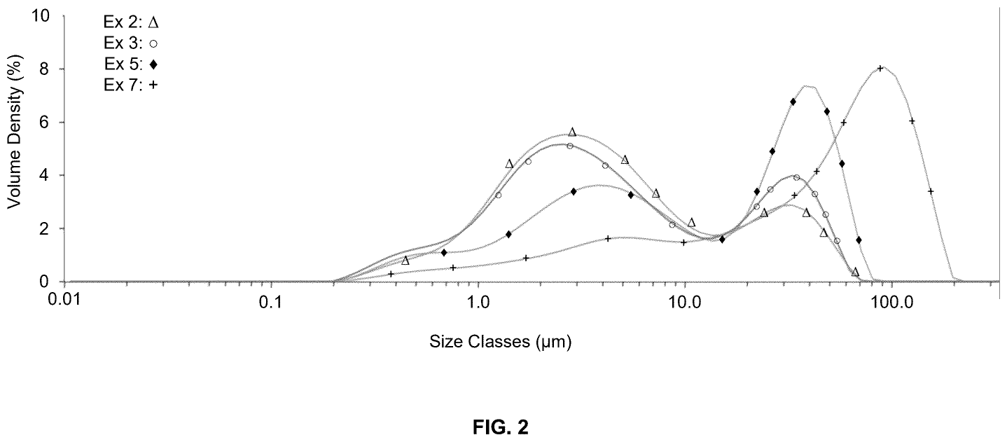

The data shows the effectiveness of the particle size growth method by mixing a sulfide based solid electrolyte material with 0 wt %, 1 wt %, 3 wt % and 5 wt % LiI then heating the mixture to a temperature of 500° C. for 1 hour. As shown in FIG. 2, the particle size distribution of the sulfide-based solid electrolyte shifts from a large volume density of particles below 10 μm to a large volume density of particles above 10 μm. The increased volume density of particles above 10 μm increases as the amount of LiI used increases.

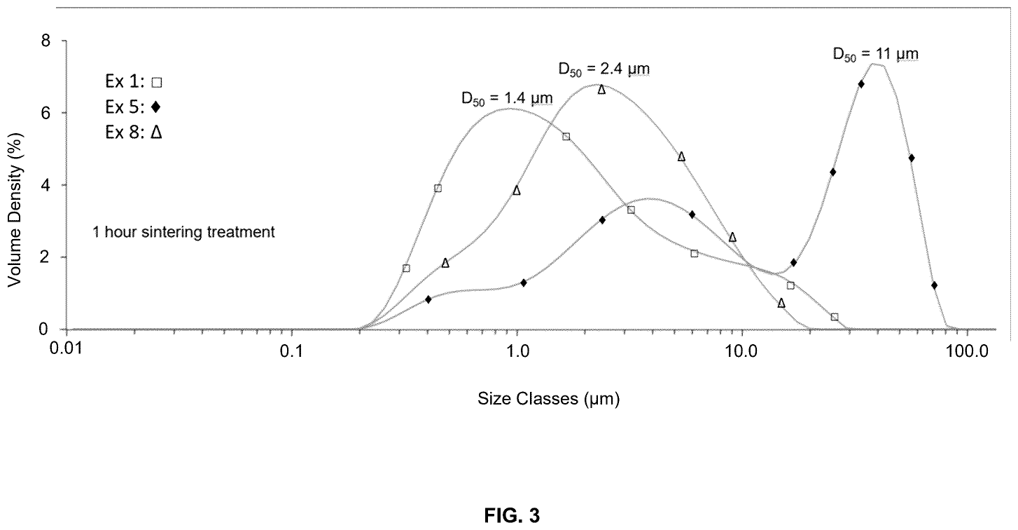

The data also demonstrated that the particle size of the sulfide-based solid electrolyte material can be increased through this method and then the electrolyte material can be milled to reduce the particle size by a desired amount. This increase and subsequent reduction of the particle size of the solid electrolyte material is shown in FIG. 3, where the particle size distribution of the materials of Examples 1, 5, and 8 are compared.

What is claimed is:

1. A solid electrolyte comprising lithium, sulfur, and phosphorus where at least a portion of a surface of the solid electrolyte is at least partially coated by an amorphous layer comprising an alkali metal halide.

2. The solid electrolyte of claim 1, wherein the alkali metal halide includes lithium iodide (LiI).

3. The solid electrolyte of claim 1, where the solid electrolyte is an Argyrodite material.

4. The solid electrolyte of claim 1, wherein the solid electrolyte has a molecular formula of:
Li_{(7-A-B)}PS_{(6-A-B)}X_{A}Y_{B},
wherein:
X and Y are each independently selected from the group consisting of fluorine, chlorine, bromine, and iodine;
$$0 \leq A \leq 2 ; \\ 0 \leq B \leq 2 ; and \\ 0 \leq A + B \leq 2.$$

5. The solid electrolyte of claim 4, wherein X is CI and B is 0.

6. The solid electrolyte of claim 4, wherein X is CI, B is 0, and 1≤A≤2.

7. The solid electrolyte of claim 4, wherein X is CI, B is 0, and 1.25≤A≤2.

8. The solid electrolyte of claim 4, wherein X is CI, B is 0, and 1.5≤A≤2.

9. The solid electrolyte of claim 4, wherein X is CI and Y is Br.

10. The solid electrolyte of claim 4, wherein X is CI, Y is Br, and 1≤A+B≤2.

11. The solid electrolyte of claim 4, wherein X is CI, Y is Br, and 1.25≤A+B≤2.

12. The solid electrolyte of claim 4, wherein X is CI, Y is Br, and 1.5≤A+B≤2.

13. The solid electrolyte of claim 1, wherein the amorphous layer coats at least 5% of a surface of the solid electrolyte.

14. The solid electrolyte of claim 1, wherein the amorphous layer has a thickness of less than 100 nm.

15. A solid electrolyte composition comprising a plurality of solid electrolyte particles and an alkali metal halide, wherein the plurality of solid electrolyte particles are dispersed in a matrix of the alkali metal halide.

16. A solid-state battery comprising a solid electrolyte comprising lithium, sulfur, and phosphorus, wherein at least a portion of a surface of the solid electrolyte material is covered by an amorphous layer comprising an alkali metal halide.

17. The solid-state battery of claim 16, wherein the amorphous layer at least 5% of the surface.

18. The solid-state battery of claim 16, wherein the amorphous layer has a thickness of less than 100 nm.

19. A solid-state battery including an anode layer, a cathode layer, and a separator layer, wherein one or more of the anode layer, the cathode layer, and the separator layer includes a solid electrolyte comprising lithium, sulfur, and phosphorus, wherein at least a portion of the solid electrolyte material is covered by an amorphous layer of an alkali metal halide, and the alkali metal halide is LiI.

20. A method for making a solid electrolyte composition comprising:
combining a solid electrolyte with an alkali metal halide;
heating the combined solid electrolyte with an alkali metal halide to melt the alkali metal halide; and
cooling the combined solid electrolyte and alkali metal halide.

21. The method of claim 20, wherein the alkali metal halide includes lithium iodide (LiI).

22. The method of claim 20, wherein the combining includes grinding, stirring, sheering, or tumbling.

23. The method of claim 20, wherein the heating is conducted at a temperature of about 250° C. or greater.

24. The method of claim 20, wherein the solid electrolyte has a molecular formula of,
Li_{(7-A-B)}PS_{(6-A-B)}X_{A}Y_{B},
wherein:
X and Y are each independently selected from the group consisting of fluorine, chlorine, bromine, and iodine;
$$0 \leq A \leq 2 ; \\ 0 \leq B \leq 2 ;$$
and
wherein 0≤A+B≤2.
